(19) United States
(12) Patent Application Publication
(10) Pub. No.: US 2026/0369254 A1
(43) Pub. Date: Nov. 19, 2026

(54) DRUM STAND

(71) Applicant: REMARKABLE Company, Taichung City (TW)

(72) Inventor: Ming Yi CHANG, Taichung City (TW)

(21) Appl. No.: 19/211,606

(22) Filed: May 19, 2025

(51) Int. Cl. G10D 13/10; F16M 11/24

(52) U.S. Cl. CPC G10D 13/28; F16M 11/245

(57) ABSTRACT

A drum stand includes a support frame and a tripod mounted under the support frame. The support frame includes an adjustment shaft and three equiangular support rods pivoted to the adjustment shaft. The adjustment shaft is fitted with a shaft sleeve having three equiangular link rods pivoted to the respective support rods. Each of the support rods is connected to an L-shaped joint having a pivotable clamping arm. When in use, the support rods can be pivoted to adjust a support height, and the clamping arms can be pivoted to adjust a support diameter. When not in use, the support rods can be pivoted inward for storage. The tripod includes an upright pole, three equiangular legs pivoted to the upright pole, a collar sleeved on the upright pole, and three equiangular connecting rods pivoted between the collar and the respective legs.

### FIELD OF THE INVENTION

The present invention relates to a drum stand for percussion instruments, and more particularly, to a height-adjustable drum stand with a folding function.

### BACKGROUND OF THE INVENTION

Generally, percussion drums are supported by stands to make it easier for the players to strike the drums. The appearance of different types of drums is different. Therefore, the design of a drum stand needs to take into account how to achieve a stable support without tipping over.

The conga stand disclosed in the U.S. Patent Application Publication No. US2006/0185496 is composed of a fixed ring and a plurality of legs on the fixed ring. Although it can achieve the basic function of holding a conga, the support is not very stable. Besides, the conga stand is fixed in size to fit a specific conga, and it cannot be folded so it takes up a lot of space when stored.

The conga stand disclosed in U.S. Pat. Nos. 5,335,575 and 7,588,228 includes leg members and slide members that can slide up and down along the leg members. The leg members of the conga stand are collapsible, so as to reduce the size of the conga stand. The positions of the slide members are adjustable, so as to change the diameter of supporting a conga. However, this folding structure is quite complex. In actual use, the width of the leg members after being unfolded is interacted with the diameter of supporting the conga, so it is not easy to adjust the leg members for holding the body of the conga tightly.

The conga stand disclosed in U.S. Pat. No. 6,040,514 includes a carrier for placement of a conga. A plurality of adjustable position blocks are slidably connected to the carrier. By adjusting the position blocks to hold the lower end of the conga, the conga stand is used for holding congas of different sizes. However, the strength of this conga stand to hold the body of the conga is too small, and the support position is too low, resulting in poor support stability. Besides, the carrier is not adjustable in height, so the conga stand is not practical.

### SUMMARY OF THE INVENTION

The primary object of the present invention is to provide a drum stand, which is adjustable in diameter for supporting a drum body stably and can be adjusted in height to meet the needs of players with different heights. The drum stand comprises a support frame and a tripod that can be folded quickly, thereby reducing the volume of the drum stand for storage.

In order to achieve the foregoing object, the present invention provides a drum stand. The drum stand comprises a support frame and a tripod mounted under the support frame. The support frame includes an adjustment shaft and three equiangular support rods that are pivotally connected to a top of the adjustment shaft. The adjustment shaft is fitted with a shaft sleeve. The shaft sleeve includes three equiangular link rods that are pivotally connected to the respective support rods. An adjustment nut is screwed to the adjustment shaft for securing the shaft sleeve in place on the adjustment shaft. Each of the support rods is connected to an L-shaped joint having a pivotable clamping arm. When in use, the support rods can be pivoted to change the angle for adjusting the support height, and the clamping arms can be pivoted to adjust the support diameter for holding drums of different sizes. When not in use, the clamp arms are folded and the support rods are pivoted to move inward for storage. The tripod includes an upright pole and an adjustment head sleeved on an upper end of the upright pole. The adjustment shaft of the support frame is screwed to the adjustment head and coupled to the tripod. Three equiangular legs are pivotally connected to the adjustment head. A collar is sleeved on the upright pole. Three equiangular connecting rods are pivotally connected between the collar and the respective legs. When the collar is moved, the three legs are pulled to move outward for supporting the support frame stably or to move inward for storage.

### BRIEF DESCRIPTION OF THE DRAWINGS

FIG. 1 is a perspective view of the present invention;

FIG. 2 is a partially exploded view of the present invention;

FIG. 3 is a schematic view of the present invention in a use state;

FIG. 4 is another schematic view of the present invention when in use, illustrating that the support height is adjustable; and

FIG. 5 is a schematic view of the present invention in a folded state.

### DETAILED DESCRIPTION OF THE PREFERRED EMBODIMENTS

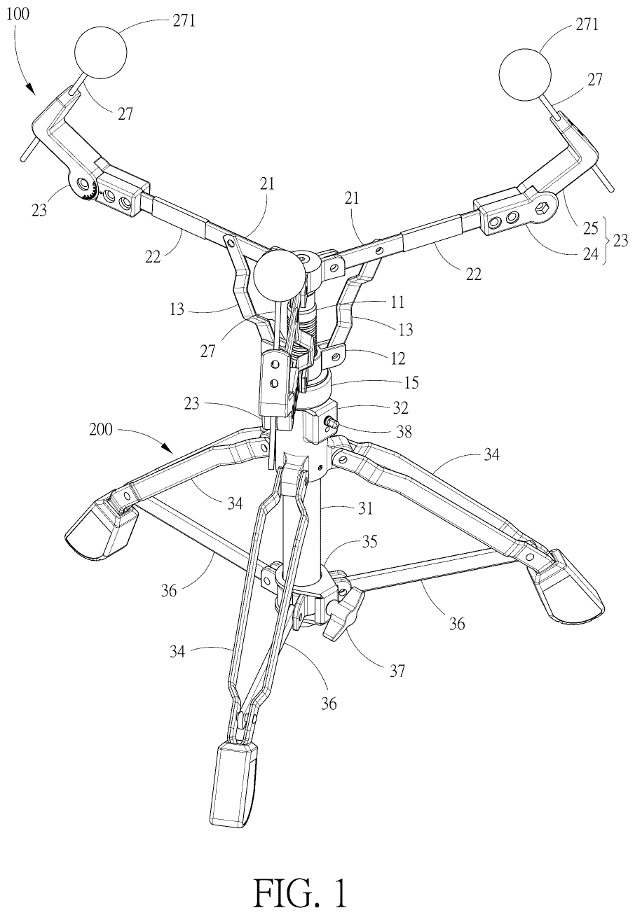

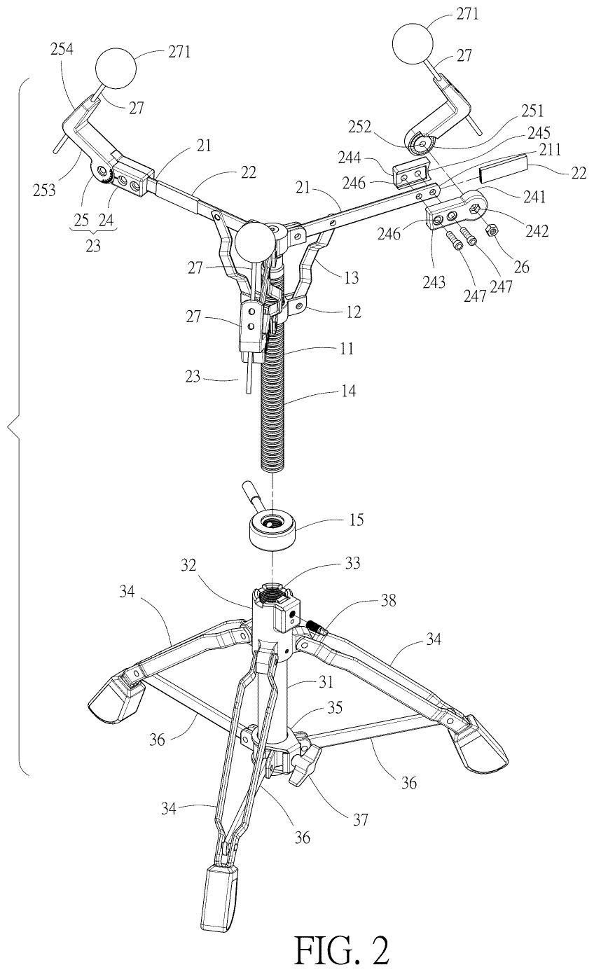

FIG. 1 and FIG. 2 illustrate a preferred embodiment of a drum stand provided by the present invention. The drum stand mainly consists of a foldable support frame 100 and a tripod 200. When in use, the tripod 200 is placed on a flat surface to support the support frame 100. The support frame 100 is configured for supporting a drum body.

The support frame 100 includes an adjustment shaft 11 and three equiangular support rods 21 that are pivotally connected to the top of the adjustment shaft 11. The support rods 21 each have a movable end 211. The adjustment shaft 11 is fitted with an axially movable shaft sleeve 12. Three equiangular link rods 13 are pivotally connected to the shaft sleeve 12. The link rods 13 are pivotally connected to the respective support rods 21. When the shaft sleeve 12 is moved upward or downward in the axial direction of the adjustment shaft 11, the link rods 13 pull the corresponding support rods 21 to extend outward or to retract inward. The adjustment shaft 11 has an external thread 14 for locking an adjustment nut 15 on the adjustment shaft 11. The adjustment nut 15 is located below the shaft sleeve 12. The adjustment nut 15 is rotatable along the external thread 14 to change its position relative to the adjustment shaft 11, which in turn secures the shaft sleeve 12 in place on the adjustment shaft 11. In this way, the pivot angle of each support rod 21 relative to the adjustment shaft 11 can be adjusted, and the size of the support surface formed by the support rods 21 can be changed to meet the needs of supporting drums with different sizes. Further, a soft protection cover 22 is fitted on each support rod 21. The soft protection cover 22 is made of soft materials such as rubber, foam and the like, which can effectively cushion the weight of the drum body 40 supported by the support rods 21 and reduce the noise generated by the vibration and friction between the drum and the support rods 21 when the drum is struck.

As shown in FIG. 2, the movable end 211 of each support rod 21 is connected to an L-shaped joint 23. The L-shaped joint 23 has a fixed elbow 24 and an L-shaped rotating elbow 25 that is pivotally connected to the fixed elbow 24. The fixed elbow 24 is coupled to the movable end 211 of the corresponding support rod 21. Mating sides of the L-shaped rotating elbow 25 and the fixed elbow 24 have annular toothed surfaces 241, 251 to mesh with each other. The center of the annular toothed surface 241 of the fixed elbow 24 has a threaded hole 242. The center of the annular toothed surface 251 of the L-shaped rotating elbow 25 has a perforation 252. A fastening element 26 passes through the perforation 252 and is locked in the threaded hole 242 for securing the L-shaped rotating elbow 25 to the fixed elbow 24, thereby securing the L-shaped rotating elbow 25 in place after being pivoted and adjusted. In this embodiment, the fastening element 26 is a combination of a bolt and a nut.

The fixed elbow 24 has a first pivot block 243 extending radially from the annular toothed surface 241 and a second pivot block 244 facing the first pivot block 243. One end of the second pivot block 244, close to the annular toothed surface 241, has a curved end face 245. The curvature of the curved end face 245 matches the outer periphery of the annular toothed surface 251 of the L-shaped rotating elbow 25, so that the L-shaped rotating elbow 25 can be pivoted smoothly relative to the fixed elbow 24 and have a larger pivot angle range for holding drum bodies 40 with different outer diameters. The first pivot block 243 and the second pivot block 244 each have at least one through hole 246 through which a screw 247 is inserted to fix the movable end 211 of the support rod 21 between the first pivot block 243 and the second pivot block 244. The height of the fixed elbow 24 relative to the adjustment shaft 11 cab be changed by adjusting the pivot angle of the corresponding support rod 21.

The L-shaped rotating elbow 25 has a first extension section 253 extending radially from the annular toothed surface 251, a second extension section 254 vertically connected to the first extension section 253, and a clamping arm 27 coupled to the second extension section 254. In this embodiment, the clamping arm 27 is movably inserted in the second extension section and extends a length above the second extension section 254. The L-shaped rotating elbow 25 is pivotable relative to the fixed elbow 24 for adjusting a support diameter encircled by the clamping arms 27 to support drums with different sizes.

As shown in FIG. 1 and FIG. 2, the clamping arm 27 can be moved axially relative to the second extension section 254 to change the length of its extension above the second extension section 254, thereby adjusting the height of the clamping arm 27 against the drum body 40, so that the position at which the drum body 40 is tightened is close to the center of gravity of the drum, so as to stabilize drum bodies 40 of different sizes. The clamping arm 27 is fitted with a soft clamping head 271. The soft clamping head 271 is made of elastic material such as rubber, silicone, etc. The soft clamping head 271 is elastically attached to the drum body 40 to clamp the drum body 40 firmly and prevent the drum body 40 from being worn due to friction with the clamping arm 27 when the drum body 40 vibrates. In this embodiment, the soft clamping head 271 is preferably a spherical clamping head, allowing it to conform closely to drum bodies 40 of different shapes.

As shown in FIG. 1 and FIG. 2, the tripod 200 includes a hollow upright pole 31 and an adjustment head 32 sleeved on the upper end of the upright pole 31. The adjustment head 32 has a screw hole 33 which is threadedly engaged with the external thread 14 of the adjustment shaft 11. Three equiangular legs 34 are pivotally connected to the adjustment head 32. The upright pole 31 is provided with a collar 35 that is axially movable under the adjustment head 32. Three equiangular connecting rods 13 are pivotally connected between the collar 35 and the respective legs 34. When the collar 35 is moved toward the lower end of the upright pole 31 by its own weight, the connecting rods 36 are driven to pull the respective legs 34 outward, forming a triangular tripod structure to achieve a stable support effect. The collar 35 includes a wing bolt 37 extending radially for fastening the collar 35 to the upright pole 31, thereby securing the legs 34 in an open state.

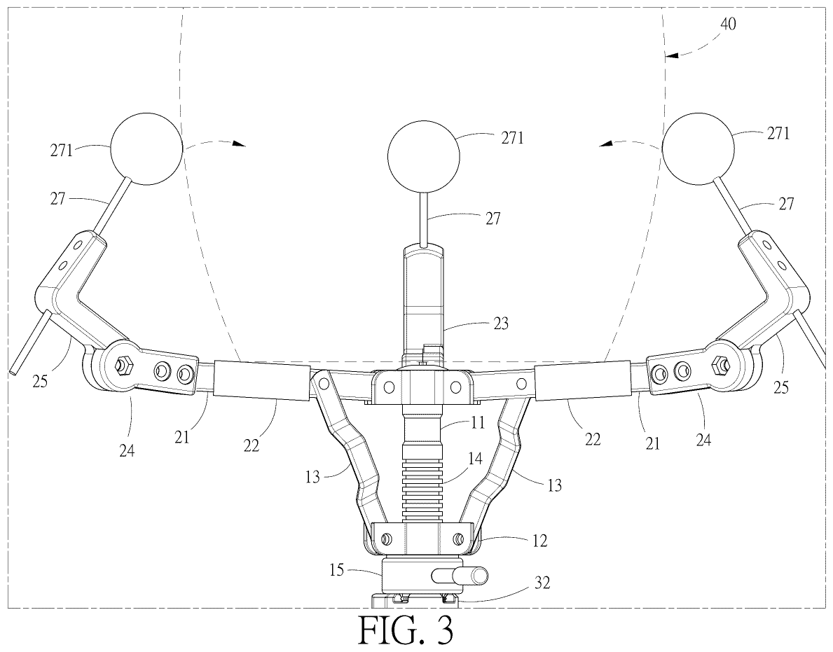

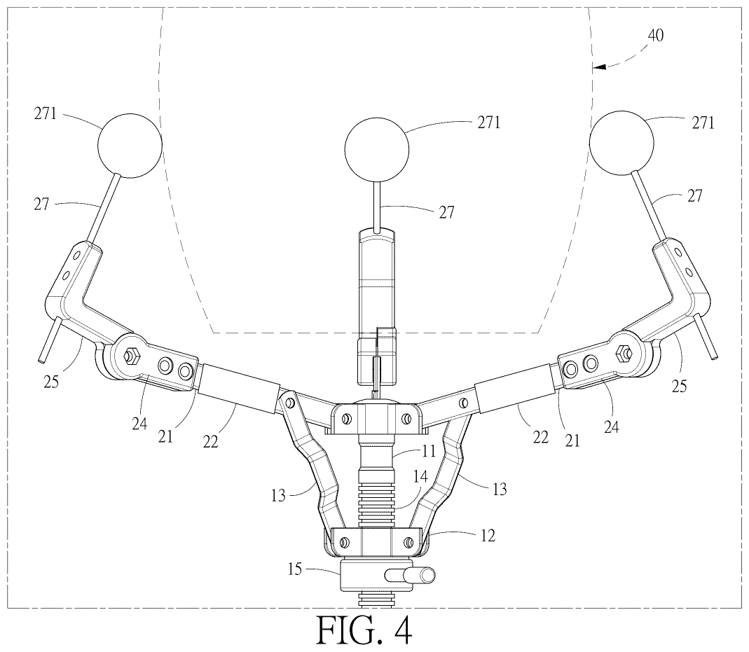

The drum stand provided by the present invention further provides a function for adjusting its support height, which can be achieved by changing the extension length of the adjustment shaft 11 relative to the upright pole 31. In this embodiment, the height adjustment is illustrated by using a drum body 40 of the same size, as shown in FIG. 3 and FIG. 4. By rotating the adjustment shaft 11 to change the position of the adjustment shaft 11 screwed to the adjustment head 32, the extension length of the adjustment shaft 11 extending out of the adjustment head 32 is adjusted to change the height for supporting the drum on the support frame 100. The adjustment head 32 is radially locked with a fastening bolt 38. The fastening bolt 38 leans against the external thread 14 of the adjustment shaft 11 to fasten the adjustment shaft 11 in the upright pole 31, so that the adjustment shaft 11 is not easily rotated or displaced during use.

The drum stand provided by the present invention can adjust the support height by changing the pivot angle of each support rod 21 relative to the central axis of the adjustment shaft 11 to change the contact position where the support rods 21 hold the bottom of the drum. The shaft sleeve 12 of the support frame 100 moves downward along the adjustment shaft 11 by its own weight, thereby driving the link rods 13 to pull the corresponding support rods 21 to pivot outward. When the support rods 21 are pivoted to a maximum angle, the support rods 21 are almost horizontal, and the support rods 21 form the largest support surface. When the adjustment nut 15 is screwed upward along the external thread 14, the shaft sleeve 12 is pushed upward. When each link rod 13 pulls the corresponding support rod 21 inward, the pivot angle of each support rod 21 relative to the central axis of the adjustment shaft 11 is reduced, and the support rod 21 is inclined. As a result, the contact point between each support rod 21 and the drum body 40 shift upward, thereby increasing the support height for the drum body 40.

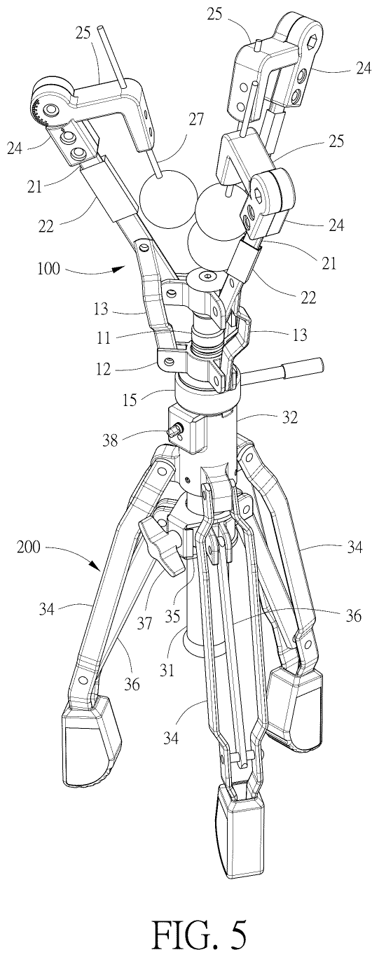

The drum stand provided by the present invention has the effect of folding and reducing the storage volume. As shown in FIG. 5, the wing bolt 37 of the collar 35 is loosened to release the collar 35, and the collar 35 is pushed to move toward the adjustment head 32, thereby driving the connecting rods 36 to pull the corresponding legs 34 to pivot and move toward the upright pole 31. Then, the wing bolt 37 is rotated and locked to re-tighten the collar 35, such that the legs 34 are in a folded state, thus completing the folding of the tripod 200. Each clamping arm 27 is pivoted to face the corresponding support rod 21. Each support rod 21 is pivoted toward the adjustment shaft 11. The link rods 13 pull the shaft sleeve 12 to move upward along the adjustment shaft 11. After each support rod 21 is pivoted to the point where it cannot be further moved, the adjustment nut 15 is rotated to lean against the shaft sleeve 12 to secure the shaft sleeve 12 in place, such that the support frame 100 is folded. After being folded, the overall volume of the drum stand is reduced, making it easier to store and carry. The length of the first extension section 253 of the L-shaped rotating elbow 25 is greater than or equal to the outer diameter of the top of the adjustment shaft 11, so that each clamping arm 27 can cross over the top of the adjustment shaft 11 and fold across each other to further reduce the volume.

Summarizing the above, the drum stand provided by the present invention can achieve the following improvements:
Firstly, the support stability is good. The present invention utilizes the stable characteristic of a triangle structure. The tripod and the support frame are formed into a triangle structure when they are unfolded, so as to improve the stability of the overall structure for supporting the drum. In addition, the height of each clamping arm against the drum body can be changed by adjusting the angle of tilt of the support rod. The length of each clamping arm can be adjusted according to the height of the drum body, allowing the clamping arms to jointly clamp at a higher position on the drum body, which is closer to the center of gravity of the drum body, thereby providing more stable support.
Secondly, the drum stand is suitable for supporting drums of different sizes. In the present invention, the pivot angle of the support rods is changed by the axial movement of the shaft sleeve, so that the support surface formed by the support rods increases with the increase of the pivot angle, and vice versa, thereby meeting the requirements for supporting drums of different sizes. The clamping arm on each L-shaped rotating elbow is pivoted to fit the size of the drum for adjusting the support diameter, so as to meet the needs of holding drum bodies of different sizes.
Thirdly, the support height can be adjusted. In the present invention, by changing the position of the adjustment shaft screwed to the upright pole, the height of the support frame relative to the placement plane can be changed. Besides, by changing the pivot angle of the support rods, the contact points between the drum body and the support rods are moved upward relative to the placement plane to adjust the support height.
Fourthly, it is easy to store and carry the drum stand. In the present invention, both the support frame and the tripod are multi-jointed linkage structures, so that each support rod can be pivoted toward the adjustment shaft, and each clamping arm can be folded between the support rods, and the legs can be pivoted and moved toward the upright pole, such that the whole drum stand is in a folded state to reduce its volume, making it more convenient to store and carry.

What is claimed is:

1. A drum stand, comprising:
a support frame, including an adjustment shaft and three equiangular support rods pivotally connected to a top of the adjustment shaft, the support rods each having a movable end, the adjustment shaft being fitted with an axially movable shaft sleeve, the shaft sleeve including three equiangular link rods, the link rods being pivotally connected to the respective support rods, the adjustment shaft having an external thread for locking an adjustment nut on the adjustment shaft, the adjustment nut being located below the shaft sleeve and configured for securing the shaft sleeve in place on the adjustment shaft, the movable end of each of the support rods being connected to an L-shaped joint, the L-shaped joint having a fixed elbow and an L-shaped rotating elbow pivotally connected to the fixed elbow, the fixed elbow being coupled to the movable end of the corresponding support rod, mating sides of the L-shaped rotating elbow and the fixed elbow having annular toothed surfaces to mesh with each other, a fastening element passing through the L-shaped rotating elbow and the fixed elbow for securing the L-shaped rotating elbow to the fixed elbow, a clamping arm being coupled to the L-shaped rotating elbow, the L-shaped rotating elbow being pivotable relative to the fixed elbow for adjusting a support diameter encircled by the clamping arms on the link rods;
a tripod, including a hollow upright pole and an adjustment head sleeved on an upper end of the upright pole, the adjustment head having a screw hole which is threadedly engaged with the external thread of the adjustment shaft, three equiangular legs being pivotally connected to the adjustment head, the upright pole including a collar that is axially movable under the adjustment head, three equiangular connecting rods being pivotally connected between the collar and the respective legs, the collar including a wing bolt extending radially for fastening the collar on the upright pole.

2. The drum stand as claimed in claim 1, wherein the fixed elbow has a first pivot block extending radially from the annular toothed surface of the fixed elbow and a second pivot block facing the first pivot block, and the first pivot block and the second pivot block each have at least one through hole through which a screw is inserted to fix the movable end of the corresponding support rod between the first pivot block and the second pivot block.

3. The drum stand as claimed in claim 2, wherein one end of the second pivot block, close to the annular toothed surface of the fixed elbow, has a curved end face.

4. The drum stand as claimed in claim 1, wherein the L-shaped rotating elbow has a first extension section extending radially from the annular toothed surface of the L-shaped rotating elbow and a second extension section vertically connected to the first extension section, and the clamping arm is movably inserted in the second extension section.

5. The drum stand as claimed in claim 4, wherein the first extension section of the L-shaped rotating elbow has a length greater than or equal to an outer diameter of the top of the adjustment shaft.

6. The drum stand as claimed in claim 1, wherein the clamping arm is fitted with a soft clamping head.

7. The drum stand as claimed in claim 1, wherein a soft protection cover is fitted on each of the support rods.

8. The drum stand as claimed in claim 1, wherein the adjustment head is radially locked with a fastening bolt for fastening the adjustment shaft to the upright pole.
